(19) United States
(12) Patent Application Publication
(10) Pub. No.: US 2021/0020039 A1
(43) Pub. Date: Jan. 21, 2021

(54) EVENT DETECTION IN TEMPORARY TRAFFIC CONTROL ZONES

(71) Applicant: 3M INNOVATIVE PROPERTIES COMPANY, St. Paul, MN (US)

(72) Inventors: Justin M. Johnson, Hudson, WI (US); James W. Howard, North Oaks, MN (US); Subhalakshmi M. Falknor, Woodbury, MN (US)

(21) Appl. No.: 17/041,576

(22) PCT Filed: Mar. 28, 2019
(86) PCT No.: PCT/US2019/024559

§ 371 Date: Sep. 25, 2020

Related U.S. Application Data
(60) Provisional application No. 62/650,525, filed on Mar. 30, 2018.

(51) Int. Cl. G08G 1/017; G08G 1/01; G08G 1/04

(52) U.S. Cl. CPC G08G 1/0175; G08G 1/04; G08G 1/0125; G08G 1/0116

(57) ABSTRACT

In some examples, a computing device may store a temporary traffic control zone compliance set (TTCZCS) comprising a set of indications of traffic control features for a temporary traffic control zone, wherein the set of indications of traffic control features represent that the temporary traffic control zone is compliant with at least one criterion; receive a set of indications of infrastructure articles from a set of sensors that detect the infrastructure articles in the traffic control zone; detect non-compliance of the at least one criterion based on an indication at least one infrastructure article in the temporary traffic control zone and at least one indication of a traffic control feature that corresponds to the infrastructure article; and perform at least one operation based on detection of the non-compliance of the at least one criterion for the temporary traffic control zone.

### TECHNICAL FIELD

This disclosure relates to pathway articles and temporary traffic control zones.

### BACKGROUND

Vehicles configured with one or more image capture devices use the information captured by the one or more image capture devices to perform one or more processes. For example, information captured by an image capture device of an autonomous vehicle may be used by the autonomous vehicle to perform one or more autonomous or semi-autonomous functions, such as driving the car without driver input, braking upon identifying a road hazard, maintaining speed relative to a second moving vehicle, or any other autonomous or semi-autonomous function. In some examples, vehicles may travel through temporary traffic control zones.

### SUMMARY

This disclosure is directed to a system that detects non-compliance in temporary traffic control zones. In some examples, a computing device may configure and store a temporary traffic control zone compliance set (TTCZCS) that include a set of indications of traffic control features for a temporary traffic control zone (TTCZ). A traffic control feature may be a data representation of any characteristic of a temporary traffic control zone (TTCZ). The TTCZCS, when configured by a safety engineer or computing device, may represent the state of the TTCZ as being compliant with one or more criteria. If the actual, physical TTCZ is configured according to the TTCZCS, then the TTCZ may be in a compliant state. If, however, one or more aspects of the TTCZ are different from the TTCZCS, then the TTCZ may be in a non-compliant state. In accordance with techniques of this disclosure, a computing device may detect non-compliance of at least one criterion based on an indication of at least one infrastructure article in the temporary traffic control zone detected by a sensor (or the absence of the infrastructure article). Conventional techniques may not include event-driven notification systems that can report non-compliance of traffic control assets to traffic control work zone plan, as described in this disclosure. Systems and techniques of this disclosure may reduce the time that the work zone is out of compliance by immediately or more quickly notifying the interested traffic control parties who configure or re-position assets, such as pathway articles back to compliance thereby reducing accidents. Conventional techniques and/or processes may also not include a data driven analysis of the work zone compliance, whereas techniques of this disclosure may compare a plan for a work zone to the enacted work zone configuration and asset locations. As such, the techniques and systems of this disclosure may be utilized for safety and performance evaluations, as well as identify areas for improvement in safety and compliance.

In some examples, a computing device may include one or more computer processors, and a memory comprising instructions that when executed by the one or more computer processors cause the one or more computer processors to: store a temporary traffic control zone compliance set (TTCZCS) comprising a set of indications of traffic control features for a temporary traffic control zone, wherein the set of indications of traffic control features represent that the temporary traffic control zone is compliant with at least one criterion; receive a set of indications of infrastructure articles from a set of sensors that detect the infrastructure articles in the traffic control zone; detect non-compliance of the at least one criterion based on an indication at least one infrastructure article in the temporary traffic control zone and at least one indication of a traffic control feature that corresponds to the infrastructure article; and perform at least one operation based on detection of the non-compliance of the at least one criterion for the temporary traffic control zone.

In some examples, a non-transitory computer-readable storage medium may be encoded with instructions that, when executed, cause at least one processor of a computing device to: store a temporary traffic control zone compliance set (TTCZCS) comprising a set of indications of traffic control features for a temporary traffic control zone, wherein the set of indications of traffic control features represent that the temporary traffic control zone is compliant with at least one criterion; receive a set of indications of infrastructure articles from a set of sensors that detect the infrastructure articles in the traffic control zone; detect non-compliance of the at least one criterion based on an indication at least one infrastructure article in the temporary traffic control zone and at least one indication of a traffic control feature that corresponds to the infrastructure article; and perform at least one operation based on detection of the non-compliance of the at least one criterion for the temporary traffic control zone.

In some examples, a method may include storing a temporary traffic control zone compliance set (TTCZCS) comprising a set of indications of traffic control features for a temporary traffic control zone, wherein the set of indications of traffic control features represent that the temporary traffic control zone is compliant with at least one criterion; receiving a set of indications of infrastructure articles from a set of sensors that detect the infrastructure articles in the traffic control zone; detecting, by at least one computing device, non-compliance of the at least one criterion based on an indication at least one infrastructure article in the temporary traffic control zone and at least one indication of a traffic control feature that corresponds to the infrastructure article; and performing, by the at least one computing device, at least one operation based on detection of the non-compliance of the at least one criterion for the temporary traffic control zone.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a system including a vehicle and temporary traffic control zone in accordance with one or more techniques of this disclosure.

FIG. 2 is a flowchart illustrating example operations in accordance with one or more techniques of this disclosure.

FIG. 3 illustrates a workflow or process to identify and determine conformance of a work zone to the work zone plan, in accordance with techniques of this disclosure.

FIG. 4 illustrates a conceptual diagram of a work zone plan in accordance with techniques of this disclosure.

FIG. 5 illustrates a conceptual diagram of grouping one or more articles into logical zones or sub-zones, in accordance with techniques of this disclosure.

FIG. 6 illustrates a conceptual diagram of incorporating sensors into one or more pathway articles, in accordance with techniques of this disclosure.

FIG. 7 illustrates a conceptual diagram of configuring asset information for temporary traffic control zone, in accordance with techniques of this disclosure.

FIG. 8 illustrates a conceptual diagram of detecting non-compliance of a workzone, in accordance with techniques of this disclosure.

FIG. 9 illustrates a workflow or process to detect an anomaly event and correct the anomaly in the work zone, in accordance with techniques of this disclosure.

FIG. 10 illustrates a conceptual diagram of a pathway article positioned out of compliance with a work zone plan, in accordance with techniques of this disclosure.

FIG. 11 illustrates a conceptual diagram for generating notifications in response to an impact sensor at a pathway article, in accordance with techniques of this disclosure.

FIG. 12 illustrates a conceptual diagram for generating different types of notifications in accordance with techniques of this disclosure.

### DETAILED DESCRIPTION

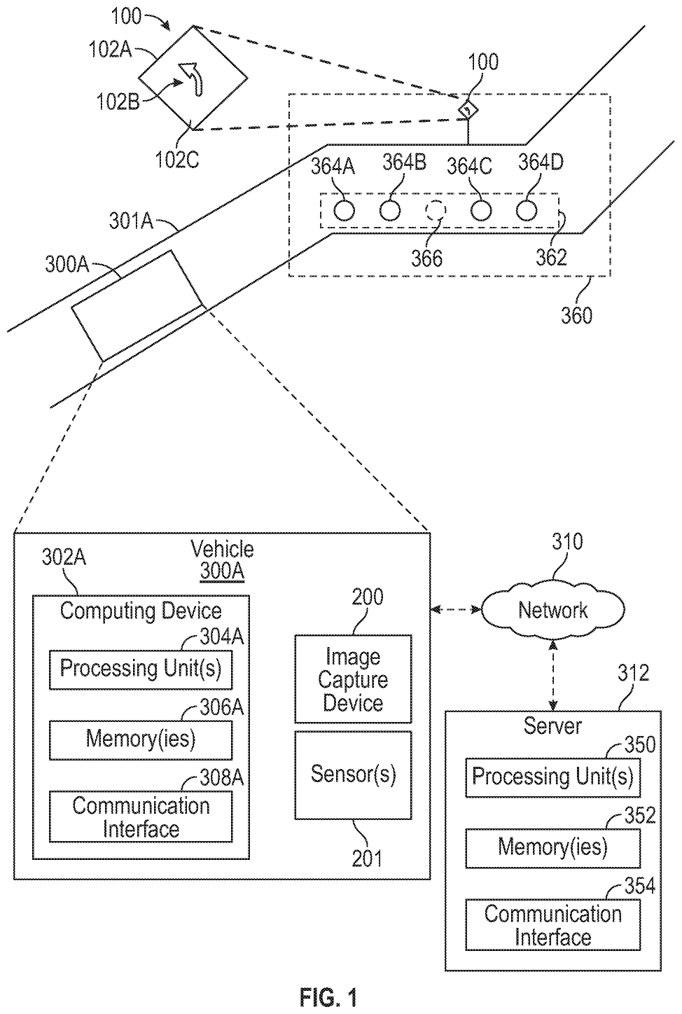

FIG. 1 illustrates a system including a vehicle and a temporary traffic control zone in accordance with one or more techniques of this disclosure. For instance, FIG. 1 illustrates vehicle 300A traveling along pathway 301A. Image capture device 200 may be integrated with a vehicle, such as in the example system illustrated in FIG. 1, which depicts vehicle 300A including at least one image capture device 200. Image capture device 200A is one example of an image capture device that may be included in vehicle 300A, and one or more image capture devices may be positioned at various locations of vehicle 300A. Vehicle 300A may include one or more other sensors, such as a LiDAR component, RFID component, magnetic detection component, or any other sensors, which may be communicatively coupled to computing device 302A.

In some examples, vehicle 300A may include computing device 302A, which may include one or more processing units 304A, one or more memories 306A, and communication interface 308A. In some examples, computing device 302A may be a vehicle head unit or included within a vehicle head unit. In other examples computing device 302A may be a portable computing device, such as a smartphone, laptop, tablet or other computing device. One or more processing units 304A may be configured to store data (e.g., an image captured by image capture device 200A and/or any pathway article data as described herein) in one or more memories 306A.

Communication interface 308A may be configured to communicatively couple computing device 302A to one or more other computing devices (e.g., a server such as server 312, image capture device 200A, sensors 201 and/or any other computing device) over one or more wired or wireless connections, one or more network connections, or one or more other types of connections. For example, communication interface 308A may be configured to communicatively couple computing device 302A to one or more networks or connections over which data may be transmitted and/or received by computing device 302A. In some examples, computing device 302A may be configured to transmit an image or data associated with the image captured by image capture device 200A or any pathway article data described herein to a second computing device (e.g., server 312 or image capture device 200A) configured to interpret, decode, read, analyze, or otherwise process supplemental information within the captured image. In other examples, computing device 302A may be configured to interpret, read, decode, analyze, or otherwise process supplemental information within the captured image with or without the assistance of a second computing device.

In the example of FIG. 1, server 312 may be configured to receive data from and/or transmit data to one or more vehicles, where vehicle 300A is one example of a vehicle. Server 312 may include one or more processing units 350, one or more memories 352, and communication interface 354. In some examples, server 312 may be a database server, application server, and/or or a web server. In some examples, server 312 may be a single server. In other examples, server 312 may be a plurality of servers. For example, server 312 may conceptually represent a cloud or set of servers. One or more processing units 350 may be configured to store data (e.g., an image and/or data associated with the image captured by image capture device 200A and/or any pathway article data as described herein) in one or more memories 352. In some examples, one or more processing units 350 may be configured to perform any image processing described herein. In such examples, one or more processing units 350 may be configured to receive an image captured by an image capture device and perform image processing thereon.

Communication interface 354 may be configured to communicatively couple server 312 to one or more other computing devices (e.g., one or more computing devices (such as computing device 302A) of one or more vehicles, one or more image capture devices (such as image capture device 200A), one or more servers, and/or any other computing device) over one or more wired or wireless connections, one or more network connections, or one or more other connections. For example, communication interface 354 may be configured to communicatively couple server 312 to one or more networks or connections over which data may be transmitted and/or received by server 312. In some examples, server 312 may be configured to transmit any pathway article data described herein to a second computing device (e.g., a computing device of a vehicle and/or an image capture device) configured to interpret, decode, read, analyze, or otherwise process the pathway article data, such as in conjunction with performing image processing on an image. In other examples, server 312 may be configured to interpret, read, decode, analyze, or otherwise process pathway article data, such as in conjunction with performing image processing as described herein with or without the assistance of a second computing device. For example, server 312 may be configured to process supplemental information within a captured image and and/or pathway article data. Regarding pathway article data, server 312 may be configured to perform one or more calculations (e.g., calculate an average) on pathway article data stored in one or more memories 352.

During operation of vehicle 300, image capture device 200 may be configured capture an image of pathway article 100. For example, image capture device 200 may be configured to capture an image of pathway article 100 as vehicle 300 approaches pathway article 100. The captured image may include, be characterized by, or be used to determine supplemental information, which may be used by image capture device 200 and/or a second computing device (e.g., a vehicle head unit of vehicle 300) to calibrate image capture device 200 and/or learn information about pathway article 100. Sensors 201 may also capture data about pathway articles.

In the example of FIG. 1, vehicle 300 includes processing unit 302 communicably coupled to image capture device 200A and/or sensors 201 via, for example, a wired or wireless connection. Image capture device 200A may be configured to capture an image and/or data associated with the image of pathway article 100. Image capture device 200A may be configured to store the captured image and/or data associated with the image in one or more memories 210A. One or more memories 210A may include short-term memory space (e.g., volatile memory space, buffer space, or the like) or long-term memory space (e.g., non-volatile memory space or the like).

In some examples, image capture device 200A may be configured to perform, via one or more processing units 212, image processing on the captured image. As used herein “image processing” may refer to interpreting, reading, decoding, assessing, and/or analyzing supplemental information present in the image of a pathway article captured by an image capture device.

In some examples, image capture device 200A and/or sensors 201 may be configured to send the captured image of pathway article 100, data derived from the image processing performed on the captured image, and/or data generated by sensors 201 to a server (e.g., server 312) over a network (e.g., network 310) for storage on the server. Individually or jointly, such information may be referred to as pathway article data. For example, pathway article data may include one or more of the following: a captured image or data derived from image processing performed on the captured image. Data derived from the image processing performed on the captured image may include, for example, data representative of a calibration determination, data representative of a disrepair determination, data representative of one or more image capture device parameters or functions, the number of blocks in a test pattern which may be checkerboard or other pattern, the brightness of the pixels in the image (e.g., the brightness of the pixels in the region(s) of the image corresponding to supplemental information 10), the relative location of different information on the pathway article (e.g., the location of supplemental information relative to other information such as supplemental information, the location of supplemental information relative to other information which may also be supplemental information), or any other data derived from the image processing. For instance, optical codes may be attached to pathway articles or any object within a pathway. Examples of optical codes are described in PCT applications PCT/US2017/053777, PCT/US2017/053788, and PCT/US2017/053801, the content of each of which is expressly incorporated by reference herein in its entirety.

Network 310 may be a wired network, a wireless network, or a combination thereof. Information stored on server 312 may be accessible by other image capture devices and/or sensors of other vehicles. Image capture devices and/or sensors of other vehicles may similarly capture an image of pathway article 100 (i.e., the same pathway article) and/or sensor data, and send similar information to server 312 for storage thereon, which may enable one or more additional determinations and/or affect any determinations made during processing. In some examples, the terms “data” and “information” may be synonymous. In other examples, the terms “data” and “information” may not be synonymous.

In some examples, pathway article data may include data indicative of any determinations derived from the processing. Data derived from the processing may include data corresponding to information associated with pathway article 100 in the captured image and/or sensor data, such as data extracted from (e.g., decoded from) second supplemental information (e.g., the unique identifier corresponding to pathway article 100). Data derived from the processing may include data indicative of any determinations derived from the image processing and/or sensor data.

As shown in FIG. 1, a portion of pathway and/or its surrounding area may be a temporary traffic control zone (TTCZ) 360. TTCZ 360 may represent a section of vehicle pathway 301A that includes temporary changes to a pathway and/or pathway infrastructure. For example, TTCZ 360 may include a construction zone, an alternate route, or other temporary section of road with changes to road infrastructure, to illustrate only a few examples. A temporary change to pathway infrastructure may include a variety of lengths of time, including a short period, such as hours, or a longer period, such as a year.

TTCZ 360 may have navigational characteristics that deviate from ordinary, planned, or otherwise designed navigational characteristics of vehicle pathway 301A. For example, TTCZ 360 may have navigational characteristics such as a traffic pattern change, worker presence, lane modifications, road surface quality, construction standards changes, or other conditions that are not normally present on or near vehicle pathway 301A.

During normal operation, vehicle pathway 301A may be a relatively low traffic roadway that includes a two-lane, single direction pathway for vehicles. Due to construction that reroutes traffic along vehicle pathway 301A, vehicle pathway 301A may contain TTCZ 360—in this instance a construction zone—that is configured to eliminate use of the right-hand lane of the pathway. As such, pathway articles 364A-364D (e.g., road construction barrels, in FIG. 1) may be placed in pathway 301A to divert traffic into the left-hand lane only, thereby closing the right-hand lane. Navigational characteristics of TTCZ 360 may include a superseded two-lane indication and an overriding one-lane indication such that, to autonomously or semi-autonomously navigate the temporary four-way stop, vehicle 300A may need to recognize the superseded two-lane indication, recognize the overriding one-lane indication, and navigate from the right-hand lane that has been eliminated temporarily into the left-land lane prior to reaching the location where the right-hand lane is eliminated and/or closed. Although TTCZ 360 is described with respect to a construction zone with a lane change in FIG. 1, techniques of this disclosure may be applied to any TTCZ having any number of characteristics.

A TTCZ may include and/or require one or more pathway articles (also referred to as infrastructure articles) to promote safety, control traffic, inform drivers, and/or provide information for ADAS systems of vehicles of characteristics of a pathway and/or region around a pathway. As described herein, a pathway article may generally refer to an article (e.g., a sign) that conveys information about a particular pathway (e.g., to assist a human or vehicle to safely navigate the pathway). A pathway article may include a sign, pavement marking (e.g., liquid, tape or raised pavement marking), barrel, bollard, light, reflector, electronic and/or communication device, or any other object positioned at or near a pathway. In some examples, a pathway article described herein may be configured to be positioned on, in, adjacent to, above, under a pathway. For example, if a pathway is water, a pathway article may be configured to be positioned on the surface of the water, underwater, above the surface of the water, or the like. As another example, if a pathway is air, a pathway article may be configured to be positioned on the ground, in the ground, or in the air above the ground (e.g., the pathway article may be positioned above the ground with or without being attached to the ground). However, these are just examples of positions. A pathway article described herein may be configured to be positioned anywhere with respect to a pathway such that the pathway article may be visible to a vehicle. In some examples, a pathway article described herein may be configured to be attached to a pathway, integrated with a pathway, attached to a pathway marking, or integrated with a pathway marking.

The type, position, quantity, duration of placement, responsible person for the pathway article, manufacturer of the pathway article, and any other characteristics for a pathway article may be defined and/or specified by one or more safety regulations, safety information, and/or safety managers/engineers. If, for example, a particular portion of a roadway must be converted from its ordinary or existing configuration to a TTCZ, a safety engineer may design or otherwise specify, with or without one or more safety regulations and/or safety information, the specified characteristics of the TTCZ. For instance, the specified characteristics may include the type, position, quantity, duration of placement, responsible person for the pathway article, and any other characteristics for a pathway article. The specified characteristics may include changes to lanes, intersections, physical features of the road surface or surrounding area of a road surface (e.g., curves, elevation changes, bumps, dips, or any other features), traffic speed limits, or any other changes from the ordinary or existing configuration of the pathway.

In some examples, the safety engineer may use a computing device that includes an application to define the characteristics of the TTCZ. Based on user input from the safety engineer, the computing device may configure and store a temporary traffic control zone compliance set (TTCZCS). In some examples, the TTCSCS may include a set of indications of traffic control features for a temporary traffic control zone. A traffic control feature may be a data representation of any characteristic of a TTCZ. The data representation may be in any suitable format. For instance, the data representation may be stored in any structured arrangement, such as extensible markup language (XML), JavaScript Object Notation (JSON), a database record, or any other format or structure. An example traffic control feature may include name:value pairs, where such names (or keys) may include but are not limited to: feature type, feature location, feature expiration, or any other characteristic. An example set of name:value pairs may include: type: [barrel], location:[lat/lon], expiration: [expiration date] [define traffic control feature], to illustrate only a few examples. In this way, a TTCZCS may include indications (or data) for one or more traffic control features in a TTCZ. By including a set of traffic control features in a TTCZCS, the actual TTCZ can be configured to comply with criteria such as safety regulations, safety information or any other conditions.

The TTCZCS, when configured by a safety engineer, may represent the state of the TTCZ as being compliant with one or more criteria. That is, if the actual, physical TTCZ is configured according to the TTCZCS, then the TTCZ is in a compliant state. If, however, one or more aspects of the TTCZ different from the TTCZCS, then the TTCZ is in a non-compliant state. For instance, TTCZ 360 may require a set of construction barrels, spaced according to a criterion, at a particular region (or sub-zone) 362 as shown in FIG. 1. TTCZCS may require, by virtue of various criteria, five construction barrels positioned at certain locations and spaced accordingly to the criteria. As shown in FIG. 1, region 362 includes four construction barrels 364A-364D, but a construction barrel is missing at location 366. Accordingly, the actual state of the TTCZ is not consistent with the TTCZCS, and therefore, TTCZ 360 is not compliant with TTCZCS. In some examples, a degree of compliance of the TTCZ may be determined and or stored by a computing device. The degree of compliance may be based on a ratio of compliant and/or non-compliant traffic control features in TTCZ 60 when compared with the traffic control features of the TTCZCS.

Techniques of this disclosure are directed to detecting non-compliance of the at least one criterion based on an indication of at least one infrastructure article in the temporary traffic control zone and at least one indication of a traffic control feature that corresponds to the infrastructure article. For instance, server 312 may store a TTCZCS for TTCZ 360. Computing device 302A may receive a portion or all of the TTCZCS for TTCZ 360 from server 312. As vehicle 300A approaches TTCZ 360, image capture device 200A and/or sensors 201 may capture and/or generate a set of indications of infrastructure articles or other aspects of TTCZ 360 from a set of sensors that detect the infrastructure articles in the traffic control zone.

Computing device 302A may detect non-compliance of the at least one criterion based on an indication at least one infrastructure article in the temporary traffic control zone from image capture device 200A and/or sensors 201 and at least one indication of a traffic control feature from the TTCZCS for TTCZ 360 that corresponds to the infrastructure article. For instance, the TTCZCS for TTCZ 360 may specify that a construction barrel is required at location 366, but image capture device 200A to detect that no construction barrel is present. In some examples, an indication (or data) of an infrastructure article from a sensor may be an absence of an infrastructure article. Computing device 302A may determine that TTCZ 360 is not compliant because no construction barrel is present at location 366 as specified by the TTCZCS for TTCZ 360. Accordingly, computing device 302A may perform at least one operation based on detection of the non-compliance of the at least one criterion for the temporary traffic control zone. For instance, computing device 302A may generate and/or send a message to one or more devices, such as server 312, a heads-up display within vehicle 300A, one or more other vehicles, or one or more devices associated with one or more persons. In some examples, computing device 302A may alter the operation of the vehicle based on detection of non-compliance. For instance, the ADAS system of the vehicle may require a particular level of driver assistance or invention that is less than fully autonomous driving if non-compliance is detected. In some examples, computing device 302A may store data that indicates the detection of non-compliance. Although the foregoing techniques were described with respect to computing device 302A, the techniques may also be performed at server 312, one or more other computing devices, or a distribution combination of any number of computing device 302A, server 312, and one or more other computing devices, any of which may interoperate to perform techniques of this disclosure.

In the foregoing example, the at least one criterion may be based at least in part on one or more of a highway transportation, safety, construction zone, or government rule or regulation. In some examples, the traffic control feature may represent at least one of a cone, barrel, barricade, lane marking, or sign in TTCZ 360. In some examples, the traffic control feature includes data that indicates one or more of a type of traffic control feature, a location or position of the traffic control feature, a region of the temporary traffic control zone that includes the traffic control feature, or a timestamp for the traffic control feature in the temporary traffic control zone compliance set (TTCZCS). In some examples, the at least one criterion indicates a position or location for the at least one infrastructure article within TTCZ 360.

In some examples, to detect non-compliance of the at least one criterion based on an indication at least one infrastructure article in the temporary traffic control zone and at least one indication of a traffic control feature that corresponds to the infrastructure article, computing device 302A may determine that a position or location of the infrastructure article in TTCZ 360 does not correspond to a position or location of the traffic control feature in the TTCZCS. In some examples, the TTCZCS comprises a map that indicates the set of indications of traffic control features at one or more positions or locations that represent that TTCZ 360 is compliant with at least one criterion.

In some examples, to perform at least one operation based on detection of the non-compliance of the at least one criterion for TTCZ 360, computing device 302A may generate an alert to one or more of a traffic safety manager or a vehicle. In some examples, to perform at least one operation, the computing device may generate data indicating a notification of an event or non-compliance in TTCZ 360. In some examples, the data may be a notification flag. In some examples, a work zone is setup and mapped by some mapping company. Information of the work zone mapped into a map remains reliable if the zone remains static, but if one or more objects are moved, the map may be inaccurate or in a different state. Data generated that represents a notification flag, or a “environment change” flag, may be used to validate that the mapping data is valid, and thus the map can still be used for navigation. If a flag is generated or an event triggers, then in order for a vehicle to be able to utilize the map again, the work zone may need to either be re-mapped or inspected, and the “environment change” flag can be reset in the computing device.

Techniques of this disclosure may further the current way that work zones are headed without other more expensive or complex technology, where a mapping company maps the work zone and then provides that to drivers to use. Using techniques of this disclosure a notification may be generated when a map is out of date. In some examples, the techniques may not require GPS knowledge of location of each asset, but merely that something is not where it was before, or has moved in some way which now renders the existing map inaccurate.

In some examples, techniques and systems of this disclosure may use techniques and systems described in U.S. Provisional Patent application entitled “MOTION-BASED PATHWAY ARTICLE AND RE-POSITIONING IN TRAFFIC CONTROL WORK ZONE”, filed Mar. 30, 2018, attorney docket number 80682US002, the entire the content of which is expressly incorporated by reference herein in its entirety. In some examples, techniques and system of this disclosure may use techniques and systems described in PCT applications PCT/US2017/053777, PCT/US2017/053788, and PCT/US2017/053801, the content of each of which is expressly incorporated by reference herein in its entirety.

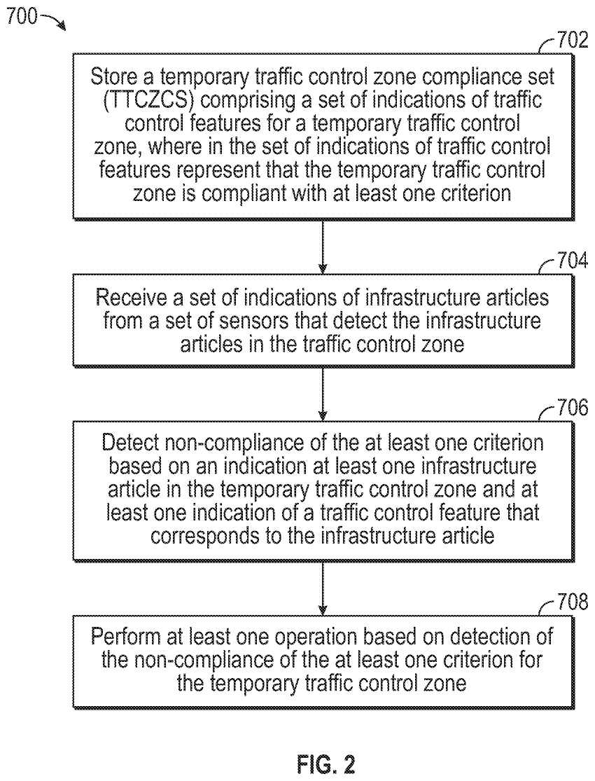

FIG. 2 illustrates a flow diagram 700 including example operations performed by a computing device, in accordance with one or more techniques of this disclosure. For purposes of illustration only, the example operations are described below as being performed by computing device 302A in FIG. 1. Some techniques of FIG. 2 may be performed by one or more image capture devices, computing devices or other hardware.

In the example of FIG. 2, computing device 302A may store a temporary traffic control zone compliance set (TTCZCS) comprising a set of indications of traffic control features for a temporary traffic control zone (702). The set of indications of traffic control features represent that the temporary traffic control zone is compliant with at least one criterion. Computing device 302A may receive a set of indications of infrastructure articles from a set of sensors that detect the infrastructure articles in the traffic control zone (704). Computing device 302A may detect non-compliance of the at least one criterion based on an indication at least one infrastructure article in the temporary traffic control zone and at least one indication of a traffic control feature that corresponds to the infrastructure article (706). Computing device 302A may perform at least one operation based on detection of the non-compliance of the at least one criterion for the temporary traffic control zone.

As described in this disclosure, techniques and systems of this disclosure may evaluate the adherence of an actual traffic control work zone to a plan of a traffic control work zone layout. In some examples, this may occur by comparing the layout of temporary traffic control devices against a plan and creating a compliance score to highlight effectiveness of maintaining the site to plan. The system may use sensors that can locate work zone furniture (e.g., infrastructure) and can communicate wirelessly to an aggregator which forwards information to a centrally located cloud.

Some of the most dangerous and challenging aspects of driving today may be encountering and traversing a work zone or temporary traffic areas for both human and machine drivers. Many reasons exist for this challenge and danger: unfamiliar situations, more abrupt traffic flow changes, reduced lane widths, conflicting driving information (i.e., driving on the wrong side of the road, or crossing old pavement markings), reduced speeds, drums or barricades with ambiguous rules (i.e., which side to drive on), small or non-existent shoulders, etc. Both humans and machines may have a difficult time interpreting the new driving rules and markings, especially at night or at higher speeds, even with adherence of the temporary traffic control techniques and best practice safety plans.

In some situations, a temporary traffic control zone may not be set up in accordance with one or more criteria. Barricades may be out of place because of a placement issue, cones or drums may have been readjusted to allow a dump truck through a crowded work area, and/or a jersey barrier may be shifted some distance of its required location to allow workers more room from the high-speed traffic. All of these aspects may be necessary to create a safe working environment to the person or group who made the modification, but what such person may not necessarily understand that they are causing deviations from the agreed upon work zone construction plan, which outlines or specifies the location, spacing and regulation for each of the temporary traffic control assets. Deviations from these plans can heighten the challenges and danger when navigating the work zone for both the driver and the construction or other workers. In some examples, a process for evaluating work zone compliance to plan to-date is a self-reported call or discussion between a Temporary Traffic Control management company and the Prime contractor or directly with the state or city agency.

Conventional techniques and/or processes may not include a data driven analysis of the work zone compliance, but the techniques and systems of this disclosure may compare a plan for a work zone to the enacted work zone configuration and asset locations. In some examples, the techniques and systems may create a compliance score which can be utilized for safety and performance evaluations, as well as identify areas for improvement in safety and compliance. The systems and techniques of this disclosure may provide more immediate response of work zone traffic control devices outside of a plan and improve the speed of the eventual correction to work zone plan. This work zone traffic control information can be sent to High-Definition (HD) mapping entities which may be used by driver/driverless vehicles and their navigation systems.

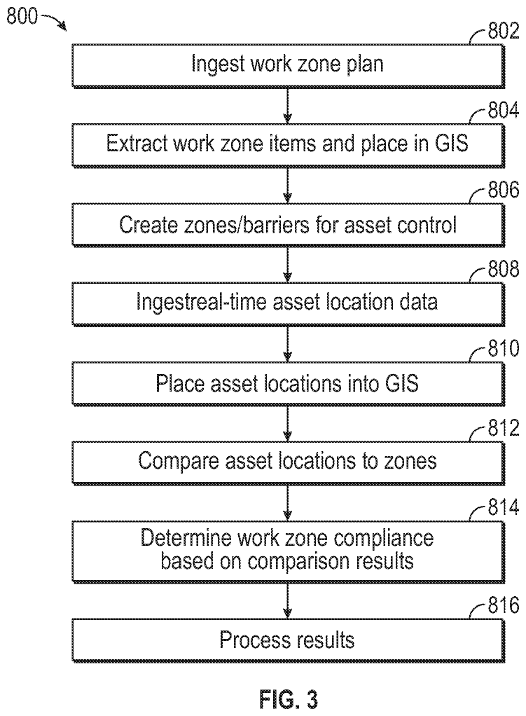

FIG. 3 illustrates a workflow or process 800 to identify and determine conformance of a work zone to the work zone plan, in accordance with techniques of this disclosure. The example is described in the following figures with respect to drums and how the drums are converted to a representation in a map from both the plan and the collected real-time information, but techniques and systems of this disclosure should be understood that it could work with signs, barricades, vehicles, even potentially pavement markings (e.g., if they have uniquely identifiable features). In some examples, any pathway article (e.g., signs and pavement markings) may have unique ID's and/or embedded information. In examples, a computing device, such as computing device 302A, server 312, and/or a computing device operated by a safety engineer. For example, a computing device may ingest or otherwise import a work zone plan, which may include or be comprised of a TTCZCS (802). The work zone plan may be defined in one or more files, datastores or other structured data. The computing device may extract work zone items (e.g., cones, signs, etc.) which may represent different traffic control features and/or regions of a pathway (804). Based on metadata in the work zone plan that indicates location data for the traffic control features, each traffic control feature may be stored and/or configured in a Geographic Information System (GIS) or similar system. The GIS system may map or otherwise configure the traffic control features at different geographic locations. In some examples, the computing device may perform one or more operations to translate a human-readable work zone plan into a machine-readable work zone plan. That is, a work zone plan may be drafted by a human and translated into machine readable data that corresponds to the work zone plan, so that the machine-readable data can be used in accordance with techniques of this disclosure. In some examples, based on different traffic control features, the computing device may generate or otherwise create different zones and/or barriers for controlling and/or mapping infrastructure assets in a TTCZ (806).

In some examples, the computing device may ingest or otherwise receive real-time asset location data about traffic, infrastructure assets, pathway conditions, or any other characteristics of the pathway (808). The computing device may place or otherwise configure or store the real-time asset locations in the GIS for further (810). Using techniques of this disclosure, the computing device may compare or otherwise process the real-time asset locations in conjunction with the TTCZ (812). For instance, the computing device may compare the real-time asset locations to the TTCZCS. The computing device may detect non-compliance of the at least one criterion based on an indication at least one infrastructure article in the temporary traffic control zone and at least one indication of a traffic control feature that corresponds to the infrastructure article (814). In some examples, the computing device may determine a discrete value whether the work zone is compliance (e.g., “compliant” or “non-compliant”). In other examples the computing device may determine a score for non-compliance. Scores may be generated by one or more of ratios, functions, weighted functions, models, or the like. In some examples, the score may be one or more integer or non-integer values. In some examples, a ratio of the number of compliant infrastructure assets to non-compliant infrastructure assets may correspond to a compliance score. In some examples, computing device may determine whether the compliance score satisfies a threshold (e.g., greater than, equal to, or less than a threshold). The threshold may be machine or human generated.

In some examples, the computing device may process the results of determining the work zone compliance (816). For example, the computing device may perform one or more operations based on detecting compliance or non-compliance. Example operations may include generating an output, such as a report and/or an alert. In some examples, the computing device may send one or more messages to one or more computing devices. In some examples, the one or more messages may cause changes in operation at the one or more computing devices (e.g., changing operation of a vehicle, outputting an alert, or presenting an alert). In some examples, the computing device may use the result to predict non-compliance in other work zones with similar configurations. In some examples, the computing device may use the result to generate recommendations on how to change the work zone to improve compliance with the at least one criterion based on an indication at least one infrastructure article in the temporary traffic control zone and at least one indication of a traffic control feature that corresponds to the infrastructure article.

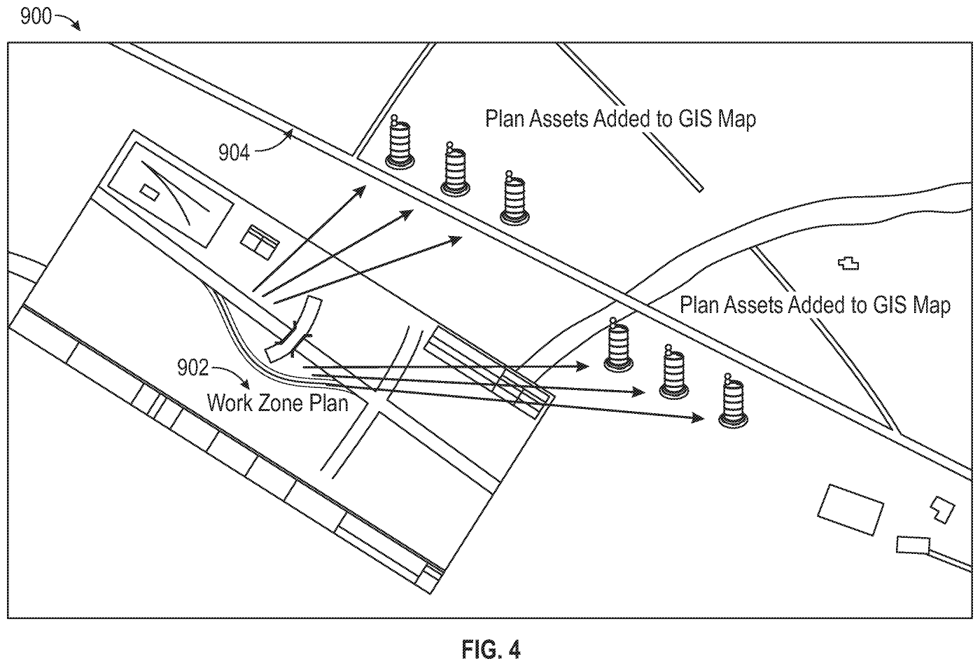

FIG. 4 illustrates a conceptual diagram of a work zone plan in accordance with techniques of this disclosure. FIG. 4 illustrates the design, specification, and ingesting of a work zone plan into a computing device. An example work zone plan 900 is shown in FIG. 4. There may be varying levels of detail depending on the CAD and technical capabilities of the agency, tools, and contractor completing the plans, but generally, a work zone plan may depict locations and purposes of temporary traffic devices, to name only a few examples (others described in this disclosure).

A safety regulation or safety information, such as Manual on Uniform Traffic Control Devices (MUTCD), may define several guidelines or criteria for minimum and maximum spacing of cones, drums or other positive guidance assets, and the plan should incorporate those guidelines as well. The same may be true for signage and pavement markings, where the rules for safety and performance are conveyed to be maintained or at a minimum met with the specifications of the work zone plan. Techniques of this disclosure are directed to determining and validating that a work zone is conforming to its work zone plan and will create a safe environment for the workers, pedestrians and drivers. In some examples, a work zone plan may be represented as or transformed by a computing device into a temporary traffic control zone compliance set (TTCZCS) comprising a set of indications of traffic control features for a temporary traffic control zone, as described in this disclosure. As shown in FIG. 4, a work zone may be configured to have one or more infrastructure articles (e.g., signs, pavement markings, drums, etc.) positioned near a roadway 904.

In some examples, an existing digital version of the work plan, and the annotations are exportable in a way that can be translated to metadata and associated in tools for determining compliance. In the event that a digital plan does not exist, then a traffic control plan received from DOT or Contractor may be analyzed and all of the furniture components may be identified, and the results may be inputted in a plan layer of a GIS map, such as illustrated in FIG. 4.

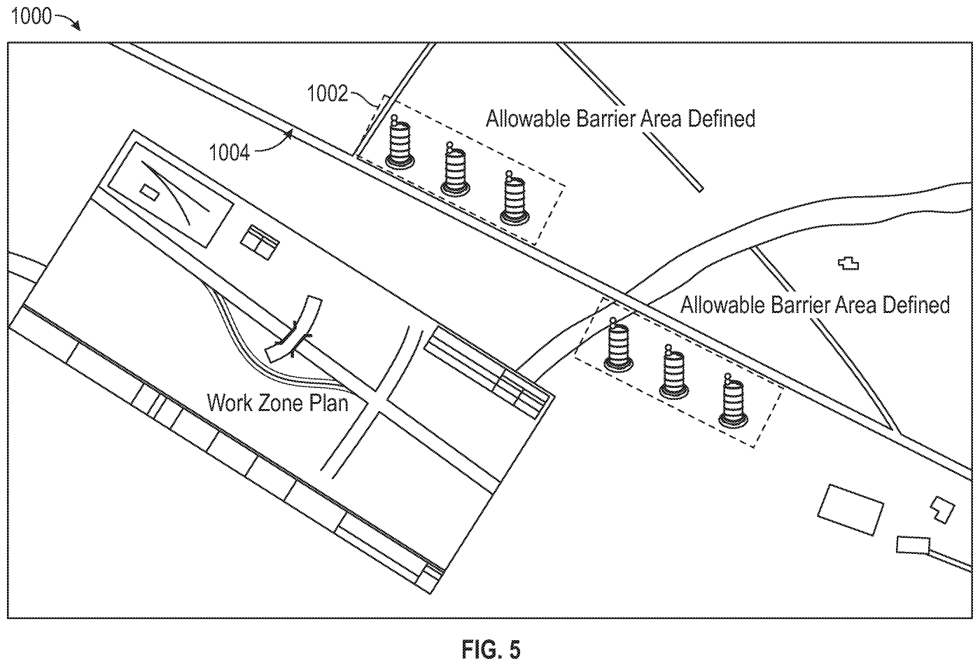

FIG. 5 illustrates a conceptual diagram of grouping one or more articles into logical zones or sub-zones, which may be physical regions at or near a pathway, in accordance with techniques of this disclosure. A computing device may group one or more articles into logical zones or sub-zones (1002) of defined zones, which may enable flexibility into the positioning of the drums or other pathway articles. This may be beneficial because the drums may create positive guidance for a driver to know where to go in the temporary situation. Such techniques may provide tolerance in the spacing of the furniture in a particular row of drums, so that mandating a specific placement is not necessary and may avoid detriment to the functionality of the system that would otherwise be introduced by the requirement of specific placement. Thus, as shown in FIG. 5, a barrier area (1002) at or near pathway 1004, or sub-zone, may be defined by a computing device for each zone of assets in which the barrels are allowed to be placed within that tolerance limit.

In FIG. 5, a system implementing techniques of this disclosure may discern barrel interval (spacing between barrels) inconsistencies, which can be useful for comparing the effectiveness of any plan. In some examples, the system may determine and ensure that each of the zones are accurate, and the barrels are placed within the tolerance bounds of each zone. Each work zone asset deviation area may account not only the spatial but also the allowable time of deviation based on the type of work zone asset. A concentric circle deviation area, for instance, may allow a computing device to identify when a work zone asset is out of compliance in all directions. If the barrel is moved out of the concentric circle (or other shape) and returned, it may be possible to properly account for situations where a barrel must be temporarily relocated for an essential process in the work zone, for example a dump truck entering the work area.

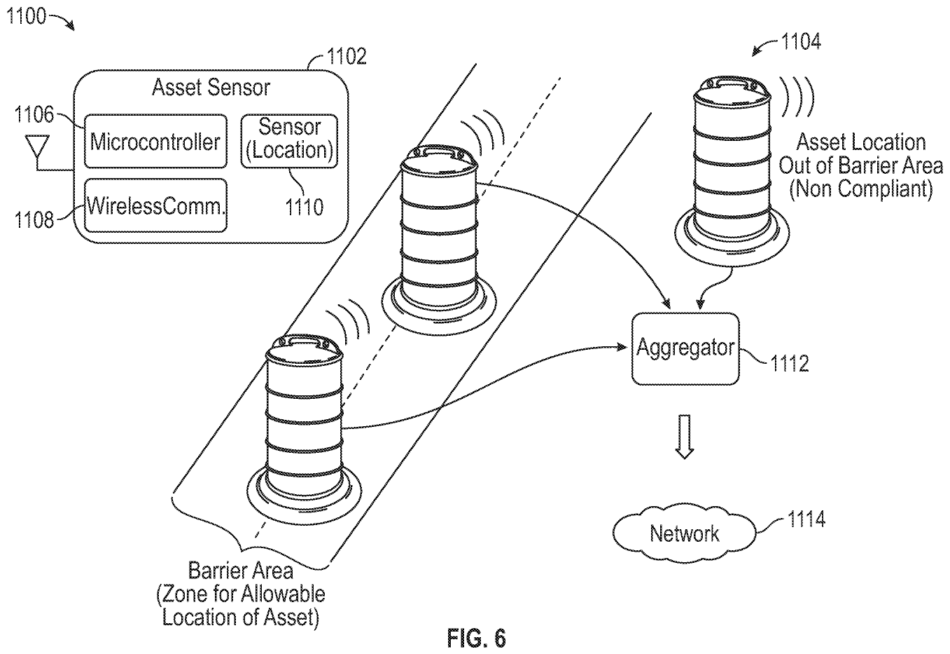

FIG. 6 illustrates a conceptual diagram of incorporating sensors into one or more pathway articles, in accordance with techniques of this disclosure. Various ways of locating assets in a work zone are possible. A system that implements techniques of this disclosure may include the components shown in FIG. 6. For instance, an asset senor 1104 may include a microcontroller 1106, sensor 1110, and wireless communication component 1108, but may include more or fewer components in other examples. Asset sensor 1104 may provide latitude/longitude coordinates and/or other location data for each asset that is tracked in an environment. Other computing devices (e.g., aggregator 1112) may receive data or other updates from those assets utilizing an asset sensor 1102. In some examples, pathway article 1104 may include asset sensor 1102. In some examples, an aggregator computing device may collect data from each pathway article that includes an asset sensor and the data may be sent to one or more computing device or cloud platform via a network 1114.

Other techniques may locate traffic control asset through a smart device (e.g., a smartphone or other portable computing device), with location information, and recording the placement location. Another way that the asset may be inventoried is through a sensor tagged asset communicating with an automated work zone system (either in the workzone or remote from the workzone), wherein one of the sensors is location aware.

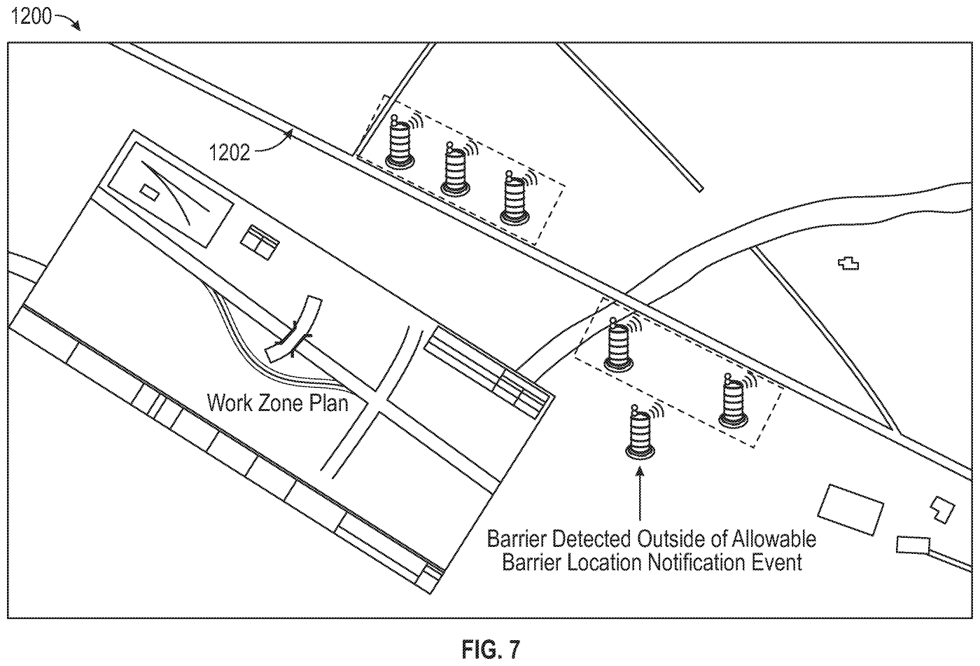

FIG. 7 illustrates a conceptual diagram of configuring asset information for temporary traffic control zone, in accordance with techniques of this disclosure. This may be referred to as ingesting, capturing, and/or storing asset location information and generating information of such assets in an asset layer on GIS map or other visual source, any of which may be performed by a computing device. The process of placing the now obtained asset locations on the map can be automated through a GIS service or layer like in Google Earth, for example. In FIG. 7, orange barrels may be representations of actual asset locations. Placing these assets on the map will allow for visual inspection by a user, and may allow one or more operations or algorithms to assess the actual positions versus the expected positions, as described in accordance with techniques of this disclosure. As shown in FIG. 7, an infrastructure article at or near pathway 1202 may be detected as non-compliant based on its position, location, or other physical state.

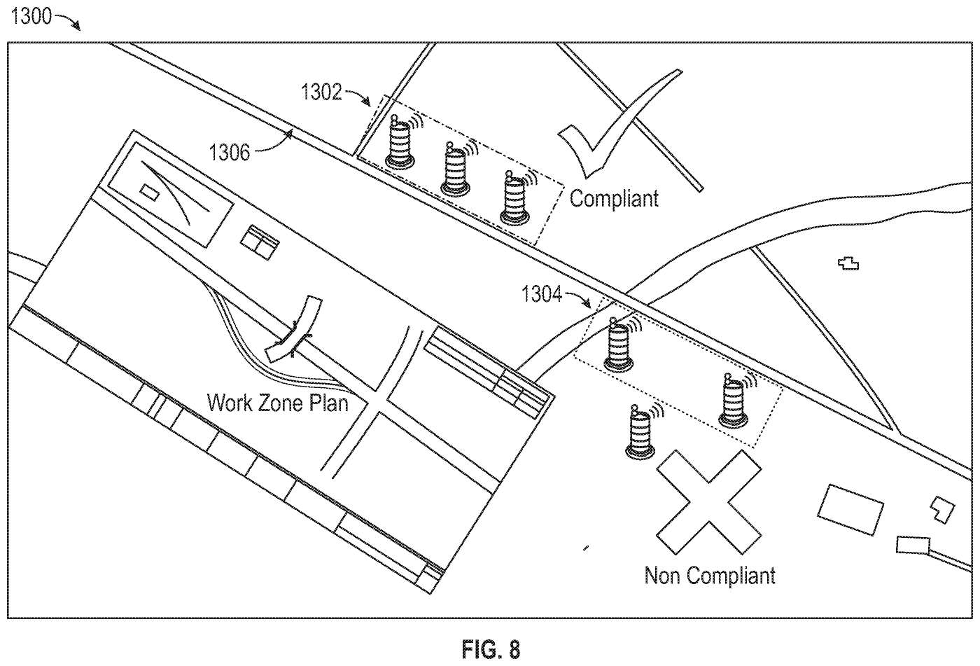

FIG. 8 illustrates a conceptual diagram of detecting non-compliance of a workzone, in accordance with techniques of this disclosure. With both the expected zones and the actual asset location data, a computing device may compare the assets in each zone (in some causes further using the allowable tolerances for that zone) and determine whether the zone is compliant with the plan or not. FIG. 8, sub-zone 1302 is compliant because all of the actual assets (orange barrels) are within the allowable zone area (dotted rectangle) and thus may be marked green with a check for illustration. In some examples the green check mark other visual indicia may be output for display by a computing device. Sub-zone 1304 at or near pathway 1306 is not compliant and thus marked red and annotated with an X for illustration. In some examples the red check X other visual indicia may be output for display by a computing device. The aggregation of all of the zones and signs and pavement marking locations etc. may be combined or otherwise processed to form a compliance score for one or more work zones. For instance, a score of 0.5 may be generated if 1 of 2 work zones are compliant. In some examples, a score may be more granularly calculated based on individual instances of non-compliance. For instance, a score of 0.17 may be generated if one pathway article of six total pathway articles is non-compliant.

In some examples, in response to detecting non-compliance, a computing device may generate a report which can be displayed or communicated. The report may include criteria. In some examples, the report may be sent to DOT and Temporary Traffic Control (TTC) authority. Additional detailed information can be determined using, for example, a work zone plan GIS layer and/or a real-time asset GIS layer, in which case the computing device can compute any deviation from the plan and compute any deviation correction alert. The computing device may also generate recommendations and/or notifications to make adjustments for compliance.

As shown in FIG. 8, techniques of this disclosure provide a data driven approach to determining and generating outputs based on work zone compliance which can be utilized for documentation of conformance/compliance, as well as to understand specifically what is and what is not compliant about the given work zone, with a continuous effort to push safety to the higher possible levels through improving conformance.

Corrections made to traffic control assets may bring work zones back into compliance. To bring compliance of a work zone into conformance with a work zone plan, the temporary traffic control company may respond to any asset deviance alerts and adjust the deviant asset. The system may continually, periodically, or asynchronously report the asset location and conformance statics which may be accumulated for analysis by reporting time to make any necessary adjustments to a work zone. This time of correction and time of error detection can also be useful data to collect in the event of an accident.

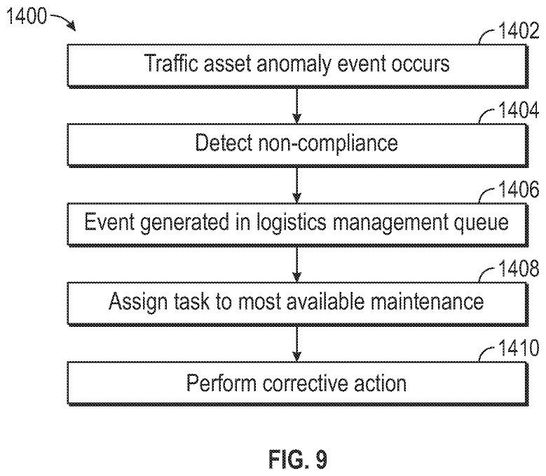

FIG. 9 illustrates a workflow or process 1400 to detect an anomaly event and correct the anomaly in the work zone, in accordance with techniques of this disclosure. Techniques and systems in FIG. 9 and the following figures describe processes/methods which may be performed by one or more computing described in this disclosure to notify non-compliant events from a traffic control asset compliance system to interested parties, such as DOT or Temporary Traffic Control company or high-definition mapping company. Any number of methods described herein may be used for notification, suggested methods are: text, email, web site alert, smart phone app, ems calls. The techniques and systems of this disclosure may improve work zone compliance and conversely reduces the time that a work zone is out of compliance which may result in work zone accidents. Some examples may include equipping the traffic control asset with a light or other visual indicator which flashes when the asset is out of compliance and the available personnel can then place the asset back into compliance.

In some instances, accidents are more likely to happen in work zones which are not in compliance to a prescribed plan. Conventional techniques do not include event driven notification systems which can report non-compliance of traffic control assets to traffic control work zone plan, as described in this disclosure. Systems and techniques of this disclosure may reduce the time that the work zone is out of compliance by immediately or more quickly notifying the interested traffic control parties who configure or re-position assets, such as pathway articles back to compliance thereby reducing accidents.

Some of the most dangerous and challenging aspects of driving today may be encountering and traversing a work zone or temporary traffic areas for both human and machine drivers. Many reasons exist for this challenge and danger: unfamiliar situations, more abrupt traffic flow changes, reduced lane widths, conflicting driving information (i.e., driving on the wrong side of the road, or crossing old pavement markings), reduced speeds, drums or barricades with ambiguous rules (i.e., which side to drive on), small or non-existent shoulders, etc. Both humans and machines may have a difficult time interpreting the new driving rules and markings, especially at night or at higher speeds, even with adherence of the temporary traffic control techniques and best practice safety plans.

There are many ways that a barrel, cone or etc. could be displaced in a work zone. A car could hit one or many and knock them out of line, a worker could move one and forget to put it back, they could be knocked out of line by construction equipment, etc. One challenge with the work zone is ensuring that the original configuration is intact, and that all the barrels or furniture are where they are planned to be, or have not succumb to something which results in their movement or tipping. Conventional processes for detecting these assets out of place or missing or tipped over may rely on someone calling to report this problem, which is a nondeterministic event, meaning it could go unreported for a long time. This nondeterministic event may occur for many reasons, not knowing the plan, not noticing a change, lower priority, etc.

Techniques and systems of this disclosure utilize sensors to detect motion and may automatically generate an event, message, or other output to initiate maintenance that resolves the issue which the sensor enabled pathway article has reported. Techniques and systems of the disclosure may improve the prioritization of work for the maintenance crew. For instance, techniques and systems of this disclosure may apply different parameters or inputs to optimize the repair of these events based on safety and importance. Several factors may include information describing the work zone, location of the work zone, presence of workers, number of assets affected, speed of work zone, traffic flow of work zone, duration of work zone, distance to closest repair/maintenance crew, etc. Using these prioritization inputs, factors, or parameters, techniques and systems of this disclosure may create a prioritized repair schedule to maximize safety and mobility for both workers and vehicles.

Conventional techniques may not provide accurate or useful measurements of the total time from the event to the repair. This is a challenge because entities responsible for repairing or otherwise correcting problems or anomalies may not know the length of time that passed until the event was reported to the TTC company. Additionally, there may be many steps which are untracked, such as after a notification is received by a maintenance crew and when the crew actually performed the repair or correction. Using sensor systems of this disclosure may enable proactive correction and automatic tracking of repairs and repair times. Systems and techniques of this disclosure may also provide statistical analysis amongst effectiveness/ efficiency of different repair crews, different TTC companies as well as state metrics etc. These metrics may be used to determine the work zone efficiencies necessary to improve and/or enable the safer work zone configurations. Systems and techniques of this disclosure may provide more immediate response of work zone traffic control devices outside of a work zone plan and eventual correction of assets to work zone plan. This work zone traffic control information can be sent to interested parties through multiple methods.

Techniques and systems of this disclosure may provide one or more technical advantages over conventional techniques, such as (a) there is a nondeterministic time when a barrel/asset has been detected to be outside of the work zone plan and/or (b) there is a nondeterministic time when the barrel/asset is placed/corrected to conform back to the original plan. For instance, there may be a large amount of time where the traffic control assets are out of place and not conforming to the intended work zone safety plan. It may take a nondeterministic amount of time to report these errors which means that the work zone may be out of compliance for a long time. It may take a nondeterministic amount of time to correct the work zone asset back into the planned safety compliance plan which means that the work zone may be out of compliance for a long time. Techniques and systems of this disclosure describe how notifications may be generated and sent timely to provide a more efficient compliance system than conventional systems. Techniques and systems of this disclosure may use multiple channels to communicate notifications to interested traffic control parties. The multiple channels provide a redundancy in the system to increase the safety quality by insuring that an event is noticed and then can be resolved.

In the example of FIG. 9, a computing device may receive or determine data that a traffic asset anomaly event occurs (1402). For instance, a traffic barrel may be moved into a non-compliance position or non-compliant event may occur in a particular region or zone, to name only a few examples. A computing device may receive this data and detect non-compliance in accordance with techniques of this disclosure (1404). The computing device may generate an event in a logistic management queue (1406). The logistics management queue may track jobs to correct zones, locations, or regions that result in non-compliance. In some examples, the logistic management queue may schedule workers, work crews, vehicles (autonomous, semi-autonomous, or non-autonomous), materials, and/or other resources to correct a non-compliance at the pathway, which may include a TTCZ. The event in the logistic management queue may represent one or more actions that may return a zone, location, or region to compliance. The computing device may assign a task based on the non-compliance event to return a zone, location, or region to compliance (1408). The computing device may send one or more notification and/or schedule the task using resources available based on the logistics management queue to return the zone, location, or region to compliance. In some examples, one or more persons and/or devices, and/or autonomous or semi-autonomous vehicles may return a zone, location, or region to compliance by performing one or more corrective actions as described in this disclosure. For instance, a barrel may be returned to a compliant location or any other necessary action may be taken to return a zone, location, or region to compliance.

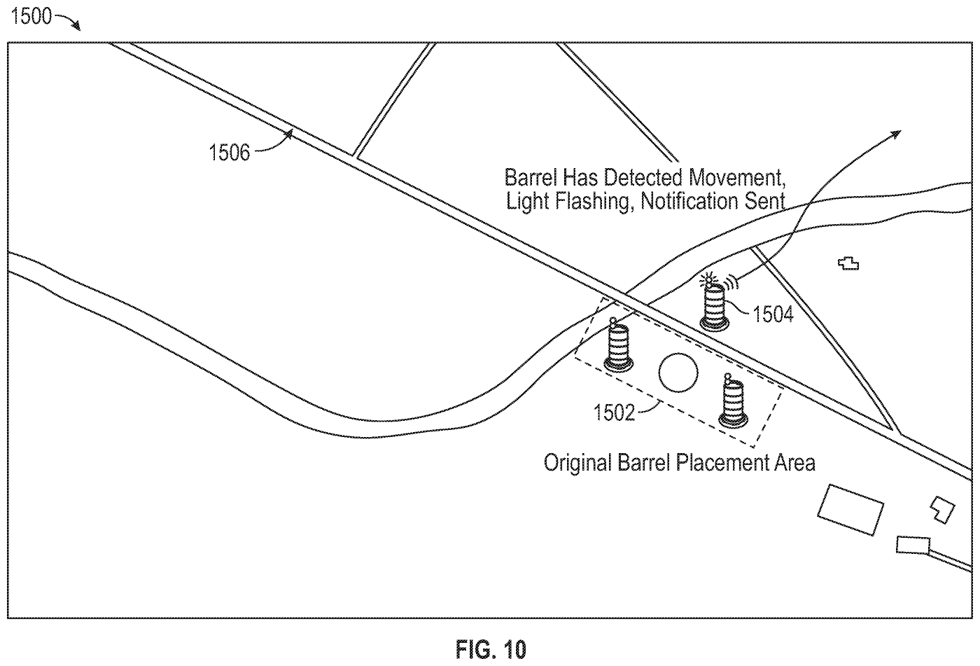

FIG. 10 illustrates a conceptual diagram 1500 of a pathway article positioned out of compliance with a work zone plan, in accordance with techniques of this disclosure. In the example process of FIG. 10, work zone assets (e.g., construction barrels) have been inventoried for work zone 1502 at or near pathway 1506. In work zone 1502, pathway article 1504 is positioned outside of work zone 1502. A workzone compliance system (e.g., server 312 in FIG. 1) may generate alerts, messages, or other outputs, in response to detecting non-compliance of work zone 1502. In the example, of FIG. 10, the system may have ingested or otherwise stored the work zone plan. Work zone assets may include location sensors, impact sensors, and posture sensors, heartbeat sensors, battery capacity indicators, or any other sensors. Collectively, sensor data from one or more sensors, may be used to detect non-compliance of the work zone based on the work zone assets or other data.

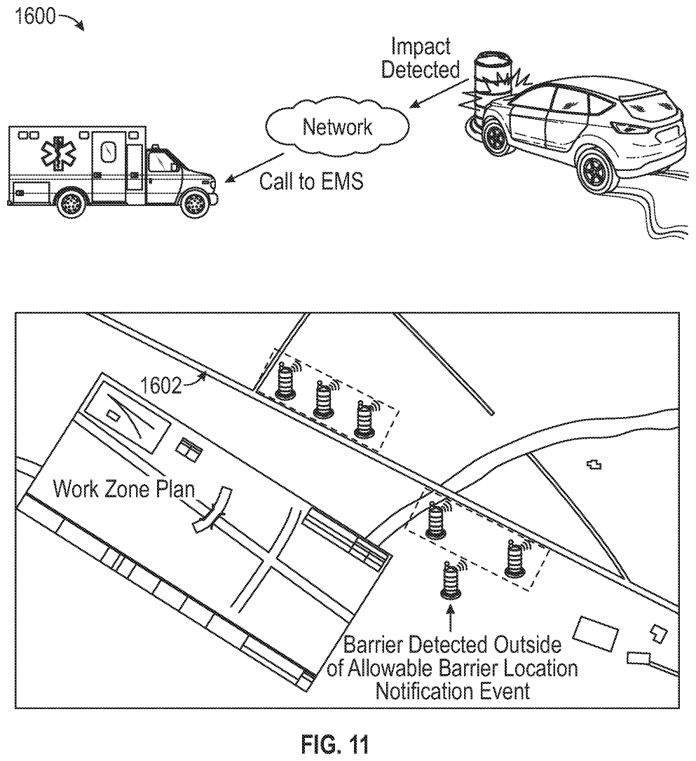

FIG. 11 illustrates a conceptual diagram 1600 for generating notifications in response to an impact sensor at a pathway article, in accordance with techniques of this disclosure. In some examples, a notification can be generated through a work zone asset that indicates a pathway article has been altered/moved from its initial placement through visual means such as a flashing LED and/or sending out an electronic notification. Traffic control assets may detect an impact event and Emergency Medical Services or other entities may be notified by a computing device of a possible vehicle collision with the asset and needs further investigation. As shown in FIG. 11, an infrastructure article near pathway 1602 may be non-compliant based on its location, position, or other physical state.

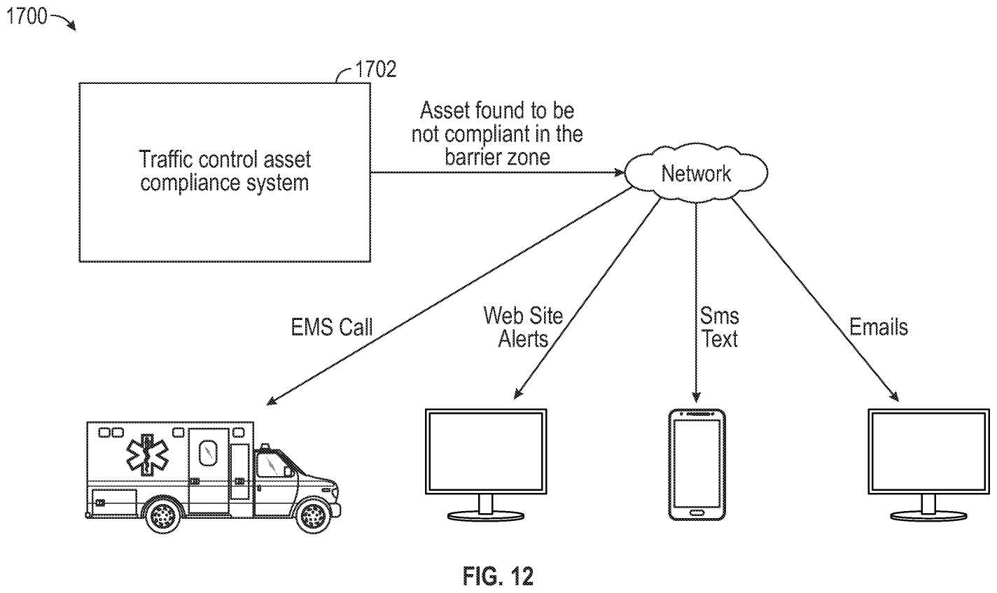

FIG. 12 illustrates a conceptual diagram 1700 for generating different types of notifications in accordance with techniques of this disclosure. For instance, notifications may be sent using any number of notification mechanisms including but not limited to: voice call, SMS text, email, web site alert or any other output. In some examples, a process may include determining non-functioning or non-compliant assets and identifying interested parties that can remedy the non-compliance. In some examples, non-compliant events are timestamped to accumulate statistics on the non-conformance to plan time. In some examples, reports may be generated. Such reports may be formatted in multiple ways, including but not limited to: text format is text, email can be text and image and link, web site alert is text and image and link, smart phone app format is text and image and link. In some examples, compliance to a work plan percentage report may be determined. In some examples, reports are sent to one or more designated entities. A report may be generated to be context specific to the receiver.

As shown in FIG. 12, a traffic control asset compliance system (TCACS) 1702 may be a computing device that implements one or more techniques of this disclosure. TCACS 1702 may, in response to detecting non-compliance, send one or more notifications to one or more other computing devices as shown in FIG. 12. In some examples, multiple notifications may be sent contemporaneously to multiple different computing devices that are associated with the non-compliance based on contextual data. Examples of contextual data may include location, event type, degree of non-compliance, user of the computing device, responsibility for the location of non-compliance, or any other contextual information.

Techniques and systems of this disclosure can improve the timeliness of correction notifications to interested traffic control parties who are responsible for keeping the work zone in compliance. The timeliness of notifications may enable workers to more rapidly repair or correct the non-compliance and may decrease the time that the work zone is out of compliance and thereby improve the safety of the work zone. Techniques and systems of this disclosure can be used to accumulate statistics on compliance to plan ratings of temporary traffic control companies which can be used for future work zone projects that the respective DOT uses for assignment. Techniques and systems of this disclosure may provide more timely, accurate information provided to the high-definition mapping companies. This timely mapping information is ultimately delivered to drivers of the work zone. Techniques and systems of this disclosure can notify emergency response personnel when an impact is detected to the work zone furniture. Techniques and systems of this disclosure may generate notifications which may be incorporated into a Temporary Traffic Control companies current route planning tool to reduce the time to repair a work zone to its intended safety setup.

As described herein, the term “pathway” may refer to any pathway, such as a vehicle pathway or a pedestrian pathway. For example, a vehicle pathway may include a roadway, a parking lot, a pathway for a car, a pathway for a bicycle, a pathway for a plane, a waterway (e.g., a channel, a buoyed path, or a marina), a pathway for a boat (e.g., a channel, or a marina), an air pathway, are area above the surface of the earth (e.g., any area with in the earth's atmosphere or outside of the earth's atmosphere, a dock, an underwater pathway, an underground pathway, a pathway on a factory floor, any other vehicle pathway, or any area in which a vehicle may travel or otherwise use. As used herein, the term “vehicle” may refer to a motorized or a non-motorized vehicle. For example, the term “vehicle” may refer to car, truck, motorcycle, bicycle, boat, water vessel, underwater vessel, space vessel, train, military equipment, airplane, remote controlled vessel, drone, helicopter, forklift, a ground vehicle, a water vehicle, an air vehicle, a space vehicle, an amphibious vehicle, a robot, a vehicle configured to travel on ground and water, a vehicle configured to travel underground, underwater, on ground, in air, in space, on a surface, or any combination thereof, a vehicle configured to travel on one or more types of pathways (e.g., an amphibious vehicle or an automobile capable of flying), or any vehicle configured with an image capture device. The term “vehicle” may refer to an autonomous vehicle, a semi-autonomous vehicle, a remote-controlled vehicle, a pathway-article assisted vehicle (PAAV), an assisted vehicle, an unassisted vehicle, a robot, or the like. In some examples, a vehicle may be configured to carry one or more occupants (e.g., one or more humans). In other examples, a vehicle may not be configured to carry one or more occupants (e.g., one or more humans). In some examples, a PAAV may include an autonomous vehicle (e.g., a fully autonomous automobile) with a computing device, a driver-assisted vehicle (e.g., a semi-autonomous automobile), an unassisted vehicle, a drone, a remote-controlled vehicle (e.g., a drone), or a human or occupant transport vehicle. A pedestrian pathway may include a sidewalk, a crosswalk, a trail (e.g., a hiking trail, a mining trail), a safety area (e.g., a safety zone on a factory floor), or any other pedestrian trail. As used herein, a pedestrian may refer to any human pathway.

The various examples of pathway articles described herein include primary information and supplemental information. In accordance with this terminology, “primary information” as used herein may, in some examples, include one or more physical properties of a pathway article. For example, physical properties of the pathway article may include the shape of a pathway article, the shapes of various components of the pathway article, and/or graphical information of the pathway article. Graphical information of a pathway article may include any text (e.g., letters, numbers, words, or the like), color(s), and/or graphics of the pathway article. For example, the text “stop” and the color red may constitute graphical information of a stop sign, and the black text and white background may constitute graphical information of a speed limit sign. The graphics of a pathway article may include any graphics driven by electricity, such as one or more lights. One or more physical properties of a pathway article may convey or otherwise represent pathway information.

As described herein, “supplemental information” may include information supplemental to the primary information. For example, supplemental information may include calibration information that is different from and supplemental to the primary information of a pathway article. Supplemental information may include information associated with the pathway article, which may include information representative of one or more physical properties of the pathway article. Information associated with the pathway article may include, for example, at least one of data representative of a unique identification number that uniquely identifies the pathway article; data representative of a type corresponding to the pathway article (for example, the type may include a sign, a channeling device, a traffic control device, a light, or a pathway marking); data representative of a location of the pathway article (e.g., GPS data); data representative of an age of the pathway article; data representative of an installation date of the pathway article; data representative of one or more physical properties of the pathway article (e.g., identification of one or more shapes of the pathway article, identification of graphical information of the pathway article, identification of one or more dimensions of the pathway article, identification of one or more colors of the pathway article, or the like); data representative of scheduled maintenance or repair of the pathway article; data representative of a replacement date for the pathway article; data representative of a manufacturer of the pathway article; data representative of a model number, part number, or lot number of the pathway article; or data representative of other information associated with the pathway article. In some examples, the supplemental information may overlap the primary information. In other examples, the supplemental information may not overlap the primary information.

In some examples, a pathway article may include supplemental information via one or more optical targets integrated with the pathway article. For example, a stop sign may be an example of a pathway article. In accordance with the techniques described herein, the stop sign may include primary information and an optical target that includes supplemental information. In this example, the primary information may include the octagonal shape of the pathway article, the color red, and the word “STOP.” The supplemental information may include calibration information that is different from this primary information. As another example, a construction barrel may be an example of a pathway article. In accordance with the techniques described herein, the construction barrel may include primary information an optical target that includes supplemental information. In this example, the primary information may include the cylindrical shape of the pathway article, the colors orange and white, and a yellow light. The supplemental information may include calibration information that is different from this primary information.

In some examples, primary information and supplemental information of a pathway article described herein may be distinguished as follows: the primary information may not be encoded and the supplemental information or a portion thereof may be encoded. For example, supplemental information or a portion thereof may be encoded in a machine-readable representation of data, such as a barcode (e.g., a one-dimensional barcode or a two-dimensional barcode). It is understood that, contrary to its name, a two-dimensional barcode does not necessarily represent information using bars. Rather, consistent with use in the industry, a two-dimensional barcode may include any pattern in two dimensions, which may include rectangles, squares, dots, or other shapes to represent information.

As another example, supplemental information or a portion thereof may be encoded such that it is not visible by the human vision system. For example, supplemental information or a portion thereof may be encoded such that it is only visible in conjunction with light having a certain frequency or wavelength or falling within a certain frequency range or wavelength range (e.g., infrared light or ultraviolet light). Such supplemental information may be described as being infrared supplemental information, ultraviolet supplemental information, or invisible supplemental information. One benefit of supplemental information that is not visible to the human vision system is that the supplemental information would not be available to distract a human (e.g., a driver of a vehicle). Instead, the human would only perceive the primary information resulting in less time analyzing the pathway article or not being confused by supplemental information thereby increasing safety.

In some examples, a pathway article may include supplemental information (e.g., calibration information) such that supplemental information or a portion thereof is invisible to the human vision system but is readable by an image capture device. In such examples, an image of the pathway article captured by an image capture device may include the supplemental information presented by the pathway article. The supplemental information in the image of the pathway article may be visible to the human vision system even though the supplemental information may not be visible to the human vision system on the pathway article when viewed directly by the human vision system. In other examples, a pathway article may include supplemental information (e.g., calibration information) such that the supplemental information or a portion thereof is visible to the human vision system and is readable by an image capture device. In such examples, an image of the pathway article captured by an image capture device described herein may include the supplemental information presented by the pathway article. The supplemental information in the image may be visible to the human vision system.

Reference to information being visible to the human vision system may refer to information being visible with light having a wavelength and/or frequency within the visible light spectrum. Similarly, reference to information being invisible to the human vision system may refer to information being visible with light having a wavelength and/or frequency not within (e.g., outside of) the visible light spectrum. For example, supplemental information that is visible to the human vision system may be integrated with a pathway article using ink, film, or other material that reflects one or more wavelengths in the visible light spectrum. As another example, supplemental information that is invisible to the human vision system may be integrated with a pathway article using ink, film, or other material that reflects one or more wavelengths in a light spectrum different from the visible light spectrum, such as the infrared light spectrum or the ultraviolet light spectrum.

As used herein, a pathway article may, in some examples, refer to a traffic control device that includes primary and supplemental information as described herein. For example, a pathway article described herein may be a traffic sign. In this example, the primary information of the pathway article may include at least one of: one or more pathway rules (e.g., speed limit, one way, no parking, or any other pathway rule), one or more warnings (e.g., “slippery when wet” text or graphic, “bridge ices before road” text or graphic, or the like), or information about the pathway (e.g., a street name sign, an exit sign, a destination and distance sign, or the like). As another example, a pathway article described herein may be a channeling device, such as an arrow board, a traffic cone, a construction barrel, a barricade, or the like. As another example, a pathway article described herein may be a pathway surface marking. As another example, a pathway article described herein may be a traffic light. As used herein, the term “traffic” may refer to vehicular traffic or pedestrian traffic.

The various examples of a pathway article described herein may provide one or more potential technical benefits. One example benefit may include enabling the assessment of an image capture device of a vehicle outside of a laboratory testing environment. For example, the techniques described herein enable assessing an image capture device in real-time while the vehicle with which the image capture device is associated is using a pathway. Real-time assessment may avoid reliance on scheduled maintenance, which may prove to be untimely or risky since the scheduled maintenance may be scheduled after a problem arises. One example benefit may include ensuring that an image capture device of a vehicle is calibrated or the like. One example benefit may include ensuring or enhancing the safe operation of a vehicle configured with an image capture device. For example, a vehicle (e.g., an autonomous vehicle or a demi-autonomous vehicle) may be configured to perform one or more autonomous or semi-autonomous vehicle functions based on information captured by an image capture device. However, if the image capture device is not calibrated, then any decision the vehicle may make based on an image captured by the image capture device may be inaccurate, which could jeopardize the safe operation of any autonomous or semi-autonomous function provided by the vehicle.

Additionally, the various examples of a pathway article described herein may provide one or more benefits described herein in various applications. For example, the various examples of a pathway article described herein may benefit operations in warehouses, factories, airports, mining sites, or any location in which a pathway article conveying primary information may be displayed, installed, or otherwise implemented.

The various examples described herein may be combined in any combination.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or like term (e.g., “processing unit”), as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

1. A computing device comprising:
one or more computer processors, and
a memory comprising instructions that when executed by the one or more computer processors cause the one or more computer processors to:
store a temporary traffic control zone compliance set (TTCZCS) comprising a set of indications of traffic control features for a temporary traffic control zone, wherein the set of indications of traffic control features represent that the temporary traffic control zone is compliant with at least one criterion;
receive a set of indications of infrastructure articles from a set of sensors that detect the infrastructure articles in the traffic control zone;
detect non-compliance of the at least one criterion based on an indication at least one infrastructure article in the temporary traffic control zone and at least one indication of a traffic control feature that corresponds to the infrastructure article; and
perform at least one operation based on detection of the non-compliance of the at least one criterion for the temporary traffic control zone.

2. The computing device of claim 1, wherein the at least one criterion is based at least in part on one or more of a highway transportation, safety, construction zone, or government rule or regulation.

3. The computing device of claim 1, where in the traffic control feature represents at least one of a cone, barrel, barricade, lane marking, or sign in the temporary traffic control zone.

4. The computing device of claim 3, wherein the traffic control feature comprises data that indicates one or more of a type of traffic control feature, a location or position of the traffic control feature, a region of the temporary traffic control zone that includes the traffic control feature, or a timestamp for the traffic control feature in the temporary traffic control zone compliance set (TTCZCS).

5. The computing device of claim 1, where the at least one criterion indicates a position or location for the at least one infrastructure article within the temporary traffic control zone.

6. The computing device of claim 1, where to detect non-compliance of the at least one criterion based on an indication at least one infrastructure article in the temporary traffic control zone and at least one indication of a traffic control feature that corresponds to the infrastructure article, the memory comprises instructions that when executed by the one or more computer processors cause the one or more computer processors to determine that a position or location of the infrastructure article in the temporary traffic control zone does not correspond to a position or location of the traffic control feature.

7. The computing device of claim 1, wherein the traffic control zone compliance set (TTCZCS) comprises a map that indicates the set of indications of traffic control features at one or more positions or locations that represent that the temporary traffic control zone is compliant with at least one criterion.

8. The computing device of claim 1, wherein to perform the at least one operation based on detection of the non-compliance of the at least one criterion for the temporary traffic control zone the memory comprises instructions that when executed by the one or more computer processors cause the one or more computer processors to generate an alert to one or more of a traffic safety manager or a vehicle.

9. The computing device of claim 1, wherein the sensor comprises one or more of an image sensor, an acoustic sensor, a light sensor, Light Detection and Ranging (LiDAR) sensor, GPS sensor, or a radio frequency sensor.

10. The computing device of claim 1, wherein to perform at least one operation based on detection of the non-compliance of the at least one criterion for the temporary traffic control zone the memory comprises instructions that when executed by the one or more computer processors cause the one or more computer processors to generate data that indicates at least one of an event or non-compliance in the temporary traffic control zone.

11. A non-transitory computer-readable storage medium encoded with instructions that, when executed, cause at least one processor of a computing device to:
store a temporary traffic control zone compliance set (TTCZCS) comprising a set of indications of traffic control features for a temporary traffic control zone, wherein the set of indications of traffic control features represent that the temporary traffic control zone is compliant with at least one criterion;
receive a set of indications of infrastructure articles from a set of sensors that detect the infrastructure articles in the traffic control zone;
detect non-compliance of the at least one criterion based on an indication at least one infrastructure article in the temporary traffic control zone and at least one indication of a traffic control feature that corresponds to the infrastructure article; and
perform at least one operation based on detection of the non-compliance of the at least one criterion for the temporary traffic control zone.

12. The non-transitory computer-readable storage medium of claim 11, wherein the at least one criterion is based at least in part on one or more of a highway transportation, safety, construction zone, or government rule or regulation.

13. The non-transitory computer-readable storage medium of claim 11, wherein the traffic control feature represents at least one of a cone, barrel, barricade, lane marking, or sign in the temporary traffic control zone.

14. The non-transitory computer-readable storage medium of claim 11, wherein the traffic control feature comprises data that indicates one or more of a type of traffic control feature, a location or position of the traffic control feature, a region of the temporary traffic control zone that includes the traffic control feature, or a timestamp for the traffic control feature in the temporary traffic control zone compliance set (TTCZCS).

15. The non-transitory computer-readable storage medium of claim 11, wherein to detect non-compliance of the at least one criterion based on an indication at least one infrastructure article in the temporary traffic control zone and at least one indication of a traffic control feature that corresponds to the infrastructure article, the memory comprises instructions that when executed by the one or more computer processors cause the one or more computer processors to determine that a position or location of the infrastructure article in the temporary traffic control zone does not correspond to a position or location of the traffic control feature.

16. The non-transitory computer-readable storage medium of claim 11, wherein to perform at least one operation based on detection of the non-compliance of the at least one criterion for the temporary traffic control zone the memory comprises instructions that when executed by the one or more computer processors cause the one or more computer processors to generate data that indicates at least one of an event or non-compliance in the temporary traffic control zone.

17. A method comprising:
storing a temporary traffic control zone compliance set (TTCZCS) comprising a set of indications of traffic control features for a temporary traffic control zone, wherein the set of indications of traffic control features represent that the temporary traffic control zone is compliant with at least one criterion;
receiving a set of indications of infrastructure articles from a set of sensors that detect the infrastructure articles in the traffic control zone;
detecting, by at least one computing device, non-compliance of the at least one criterion based on an indication at least one infrastructure article in the temporary traffic control zone and at least one indication of a traffic control feature that corresponds to the infrastructure article; and
performing, by the at least one computing device, at least one operation based on detection of the non-compliance of the at least one criterion for the temporary traffic control zone.

18. The method of claim 17, wherein the at least one criterion is based at least in part on one or more of a highway transportation, safety, construction zone, or government rule or regulation.

19. The method of claim 17, wherein the traffic control feature represents at least one of a cone, barrel, barricade, lane marking, or sign in the temporary traffic control zone.

20. The method of claim 17, wherein detecting non-compliance of the at least one criterion based on an indication at least one infrastructure article in the temporary traffic control zone and at least one indication of a traffic control feature that corresponds to the infrastructure article comprises determining that a position or location of the infrastructure article in the temporary traffic control zone does not correspond to a position or location of the traffic control feature.
